(19) United States
(12) Patent Application Publication
(10) Pub. No.: US 2025/0252067 A1
(43) Pub. Date: Aug. 7, 2025

(54) REMOTE NODE CONTROL USING RDMA

(71) Applicant: HUAWEI TECHNOLOGIES CO., LTD., Shenzhen (CN)

(72) Inventors: Ben-Shahar Belkar, Hod Hasharon (IL); Michael Hirsch, Hod Hasharon (IL); Amit Geron, Hod Hasharon (IL); David Ganor, Hod Hasharon (IL)

(73) Assignee: HUAWEI TECHNOLOGIES CO., LTD., Shenzhen (CN)

(21) Appl. No.: 19/169,821

(22) Filed: Apr. 3, 2025

Related U.S. Application Data
(63) Continuation of application No. PCT/EP2022/077426, filed on Oct. 3, 2022.

(51) Int. Cl. G06F 13/16

(52) U.S. Cl. CPC G06F 13/1668

(57) ABSTRACT

A first node, a second node, and one or more third nodes for controlling a remote node via RDMA connection are provided. The first node is connected by RDMA connection to the second node and the third nodes, and the second node is connected by RDMA connection to the third nodes. The first node receives a read request for data from the second node, determines at which third node the data is available, and causes the third node to send the data to the second node. The third node is caused to send the data by receiving a RDMA write request or a send for a command from the first node. The third node sends the data by performing a RDMA write operation or a send operation in response to the command written by the first node directly to a send queue at the third node.

### CROSS-REFERENCE TO RELATED APPLICATIONS

This application is a continuation of International Application No. PCT/EP2022/077426, filed on Oct. 3, 2022, the disclosure of which is hereby incorporated by reference in its entirety.

### TECHNICAL FIELD

Embodiments of the present disclosure relate to remote direct memory access (RDMA) used in the field of network computing and storage systems. In particular, the disclosure relates to controlling a remote RDMA node via a RDMA connection, that is, by using RDMA.

### BACKGROUND

Modern efficient storage systems aim to provide access to ever-growing amounts of data. A common design is to have a front-end node, to which an application connects, and multiple back-end nodes accessing and/or holding the data itself. An application that is served by a storage system usually communicates only with the front-end node, thus, any input/output (IO) operation requires another extra IO operation between the front-end node and one or more of the back-end nodes.

The front-end node may hold a “map” of all the data locations in the back-end nodes. Using multiple back-end nodes enables to partition the data (referred to as “sharding”), to reduce access latency, to allow concurrent parallel access to the data, to provide fault tolerance, and/or to allow upgrades without service interruption. Cloud environments are a typical use-case of such partitioning. Another example is database caching, wherein the front-end node caches frequently accessed data, and the back-end nodes hold all the data.

Writing data to and reading data from a storage system, whether this storage system is centralized or network distributed, requires involvement of core processing units (CPUs) in each of the participating nodes, running either the front-end software or the back-end software or both.

Some conventional protocols enable an application to use and access a remote non-local storage, as if the storage was locally installed. To this end, a target (i.e., a node that is directly attached to one or more storage devices) may support a plurality of IO queues, wherein each IO queue can support multiple IO commands. This allows a great degree of parallelism and control over IO operations. An initiator may send one or more commands to the target, wherein the commands may control and manipulate one or more of the remote IO queues at the target. The target may execute the commands on behalf of the initiator.

The control of the remote IO queues reduces the processing and memory requirements of the initiator's CPU and network interface card (NIC), respectively, as it enables the target to do the “heavy lifting”. For instance, the target may set the priority of serving IO queues and IO commands (e.g., based on factors that the initiator cannot be aware of, like the state of its local storage devices), or may set relative priorities between unaware different initiators (e.g., based on a number of connected initiators, fairness, and QoS).

RDMA is a technology that allows applications to perform memory access operations on remote memory, installed in a remote network node. The RDMA protocol stack is offloaded, relatively easily, to an RDMA NIC (RNIC), thus reducing a node's CPU requirements to perform networking functions. RDMA is now widely used in modern datacenters and in computer-clusters, as it provides low-latency remote memory access operations together with high network bandwidth.

### SUMMARY

The following description with respect to FIG. 1 illustrates some particular issues addressed by this disclosure in view of the above-explained background technology.

FIG. 1 outlines a scenario with three nodes, which are respectively denoted by “A”, “B” and “C”. Node A runs an application, node B holds a mapping of locations and data, and node C holds the data itself. This scenario bases on the assumption that IO operations in any network-based, distributed and/or aggregated memory or storage could be further accelerated by using a delegation node, which completely offloads (i.e., avoids) any use of the node's CPU, and only dispatches IO commands to another third party node. In the scenario of FIG. 1, the node B is such a delegation node.

If node A wishes to read data, it sends to node B a read-request with a pair of {key, A-addr}, wherein the key identifies the requested data and “A-addr” is an address in the memory space of A, into which A expects the data to be read (using RDMA). Node B may have the data, e.g., if it was cached at the memory space of node B, and thus node B may reply to the request of node A immediately by sending a read response including the data. In some cases, however, node B does not have the data, but node B knows where the data is. Thus, node B uses the key and its mapping to locate the data in node C.

Node B in this case provides back to node A the location of the requested data at node C, or replies that it does not hold the data, and lets node A request the data directly from node C. Because of this role, node B can be thought of as the delegation node. Node C can be thought of as a serving node. Notably, the scenario of FIG. 1 is a general one and could represent a case where node A is an application server, node B is a page-cache server and node C a storage server. The key, in this case, may be the address of a page and the data may be the content of the page. Node C might even not be a storage server, but yet another level of caching. where another server (node D) may be the server holding the contents of the page.

An issue with the type of operations shown in FIG. 1 is the requirement for serial operation of node A. That is, node A first initiates a communication to receive the location of the data, then performs some processing, and then initiates another communication to receive the data itself. The total latency of retrieving the data further depends on processing time in the nodes B and C, and in addition also on the network's round trip times (RTTs).

This leads to a considerable processing time required by the CPU of node A to find the location of the data and to finally retrieve it. Further, a high network traffic volume and bandwidth are used for a single read in case of a cache server miss. And the overall latency is quite high for the completion of the read request sent by the initiator node A.

Embodiments disclosed herein reduce the processing time, the latency, and the network's bandwidth used for finding and retrieving data by an initiator node in a network storage system.

A first aspect of this disclosure provides a first node, which is connected by RDMA connection to a second node and to one or more third nodes, respectively, the first node being configured to: receive, from the second node, a read request for data; and if the requested data is not available at the first node: determine at which of the one or more third nodes the requested data is available; and cause the determined third node to send the requested data over a RDMA connection to the second node.

Thus, the first node does not have to respond to the second node with a negative answer regarding the data. Also, the second node does not have to request the data from the third node. Consequently, the processing time of the second node, the latency of the data retrieval, and the bandwidth used for finding and retrieving data by the second node are significantly reduced.

In an implementation form of the first aspect, the read request comprises information that identifies and grants access to a memory in the first node and a memory in the second node, an address space of the first node, and an address space of the second node.

This allows the first node to convey, to the third node, the relevant information for writing the data to the second node.

In an implementation form of the first aspect, for causing the determined third node to provide the requested data to the second node, the first node is configured to trigger a write of the requested data by the third node into the address space of the second node.

In an implementation form of the first aspect, the first node is further configured to control the RDMA connection from the third node to the second node.

Thus, the third node does not have to do any processing, or only significantly reduced processing.

In an implementation form of the first aspect, the first node comprises an address of a send queue at the third node, for sending from the third node to the second node, and an address of a doorbell register of this send queue.

Thus, the first node can directly trigger the send queue of the third node to perform the write of the requested data to the second node.

For instance, the send queue is a queue of one or more commands. The first node may be configured to append a command to the send queue in the third node, and may trigger the third node to execute the appended command. Notably, the send queue does not perform the one or more commands, but is configured to hold the one or more commands to be processed.

In an implementation form of the first aspect, for triggering the write of the requested data by the third node, the first node is configured to send at least one RDMA write request to the address of the send queue at the third node and/or to the address of the doorbell register of this send queue.

In an implementation form of the first aspect, the at least one RDMA write request comprises information that identifies and grants access to a memory in the third node and a memory in the second node, an address space of the third node, and the address space of the second node.

This enables the data to be written, by the third node, from the third node to the second node.

In an implementation form of the first aspect, the at least one RDMA write request comprises one of: a RDMA write-with-immediate request for the data and for a notification; a RDMA write request for the data and a send request for a notification; a RDMA write request for the data and a send-with-immediate request for a notification.

In this way, the second node may obtain information that the requested data retrieval is completed.

In an implementation form of the first aspect, for causing the determined third node to provide the requested data to the second node, the first node is configured to send a read request to the third node, wherein the read request indicates that the requested data is to be written by the third node into the address space of the second node.

In this case, the read request received by the third node from the first node is like a read request received by the third node from the second node.

In an implementation form of the first aspect, the read request comprises information that identifies and grants access to a memory in the third node and a memory in the second node, and the address space of the second node.

This enables the direct sending and writing of the data by the third node to the second node.

In an implementation form of the first aspect, the first node is further configured to, if the requested data is available at the first node, send the requested data to the second node over the RDMA connection to the second node.

Thus, if the data is for instance cached at the first node, the second node can obtain the data quickly.

In an implementation form of the first aspect, the first node is further configured to, if the requested data is not available at the first node and if the first node is unable to determine the third node at which the requested data is available, send a response to the second node indicating that the requested data is not found.

A second aspect of this disclosure provides a second node, which is connected by RDMA connection to a first node and to one or more third nodes, respectively, the second node being configured to: send a read request for data to the first node; and receive the requested data from one of the third nodes.

Thus, the second node does not have to request the third node for the data, if the data is at the third node but not at the first node. Consequently, the processing time of the second node, the latency of the data retrieval, and the network's bandwidth used for finding and retrieving data by the second node are significantly reduced.

In an implementation form of the second aspect, the read request comprises information that identifies and grants access to a memory in the first node and to a memory in the second node, an address space of the first node, and an address space of the second node.

In an implementation form of the second aspect, the second node is further configured to obtain a notification of completion which indicates that the requested data has been written to the address space of the second node, wherein the notification of completion is obtained by one of: polling a completion queue of the second node for the notification of completion after sending the read request; receiving an event indicating that the notification of completion can be polled from the completion queue.

In this way, the second node knows that the data is received and can conclude the data retrieval.

A third aspect of this disclosure provides a third node which is connected by RDMA connection to a first node and to a second node, respectively, the third node being configured to: receive a RDMA write request or an send for a command from the first node; and provide the data to the second node by performing a RDMA write operation in response to the command written by the first node directly to a send queue at the third node; or provide the data to the second node by performing a send operation in response to the command written by the first node directly to a send queue at the third node.

Thus, the third node can serve the request of the second node, although it has not been directly received from the second node but from the first node. The second node does not have to request the data from the third node in this case. Consequently, the processing time of the second node, the latency of the data retrieval, and the network's bandwidth used for finding and retrieving data by the second node are significantly reduced.

In an implementation form of the third aspect, the third node is configured to: perform, as the RDMA write operation, a write-with-immediate, or a write and send operations, or a write and send-with-immediate operations.

In an implementation form of the first aspect, the third node is configured to execute the command written to a send queue at the third node that provides the data into an address space of the second node.

In an implementation form of the first aspect, if the first node directly writes the command to the send queue of the third node, the third node is configured to provide the data to the second node without processing at the third node, and/or without controlling a receive queue at the third node, for sending from the third node to the second node, and a doorbell register of the send queue.

This significantly reduces the processing load on the third node's CPU.

In an implementation form of the first aspect, if the third node receives the command via a send from the first node, the third node is configured to provide the data to the second node by initiating the execution of the operation indicated by the RDMA command to the second node, and/or by controlling a receive queue at the third node, for sending from the third node to the second node.

A fourth aspect of this disclosure provides a method for a first node, which is connected by RDMA connection to a second node and to one or more third nodes, respectively, the method comprising: receiving, from the second node, a read request for data; and if the requested data is not available at the first node: determining at which of the one or more third nodes the requested data is available; and causing the determined third node to send the requested data over a RDMA connection to the second node.

The method of the fourth aspect may be extended by implementation forms that correspond to the implementation forms of the first node of the first aspect. The method of the fourth aspect and its implementation forms may provide the same advantages as described above for the first node of the first aspect and its respective implementation forms.

A fifth aspect of this disclosure provides a method for a second node, which is connected by RDMA connection to a first node and to one or more third nodes, respectively, the method comprising: sending a read request for data to the first node; and receiving the requested data from one of the third nodes.

The method of the fifth aspect may be extended by implementation forms that correspond to the implementation forms of the second node of the second aspect. The method of the fifth aspect and its implementation forms may provide the same advantages as described above for the second node of the second aspect and its respective implementation forms.

A sixth aspect of this disclosure provides a method for a third node, which is connected by RDMA connection to a first node and to a second node, respectively, the method comprising: receiving a RDMA write request or a send for a command from the first node; and providing the data to the second node by performing a RDMA write operation in response to the command written by the first node directly to a send queue at the third node; or providing the data to the second node by performing a send operation in response to the command written by the first node directly to a send queue at the third node.

The method of the sixth aspect may be extended by implementation forms that correspond to the implementation forms of the third node of the third aspect. The method of the sixth aspect and its implementation forms may provide the same advantages as described above for the third node of the third aspect and its respective implementation forms.

A seventh aspect of this disclosure provides a computer program comprising instructions which, when the program is executed by a computer, cause the computer to perform the method according to one of the fourth aspect, fifth aspect, or sixth aspect.

An eighth aspect of this disclosure provides a non-transitory storage medium storing executable program code which, when executed by a processor, causes the method according to the fourth aspect, fifth aspect or sixth aspect to be performed.

In summary of the above aspects and implementation forms of this disclosure all nodes are RDMA connected to enable sending RDMA requests and receiving and serving these RDMA requests. The first node (delegation node) has direct access to the command queue of the third node (serving node or storage node). The first node may forward RDMA requests, received from the second node (requestor node or initiator node), directly, e.g., without CPU involvement, to the third node (storage node) that actually serves the request. The first node may use the operation's meta-data to create a command (e.g., a work queue element (WQE)) in the third node's special remotely-controlled queues, so that the third node can service the request immediately without additional information.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of embodiments, a functionality or step to be performed by external entities is not reflected in the description of a detailed element of that entity which performs that step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of embodiments in relation to the enclosed drawings, in which

FIG. 1 shows an implementation of data access with three nodes.

FIG. 2 shows a first node, a second node, and a third node, according to embodiments of this disclosure.

FIG. 3 shows a conceptual flow of messages to return data to a second node, according to a first example of this disclosure.

FIG. 4 shows, for the first example of this disclosure, RDMA operations and fields to return the data to the second node.

FIG. 5 shows RDMA operations and fields to return data to the second node, according to a second example of this disclosure.

FIG. 6 shows a method for a first node according to embodiments of this disclosure.

FIG. 7 shows a method for a second node according to embodiments of this disclosure.

FIG. 8 shows a method for a third node according to embodiments of this disclosure.

### DETAILED DESCRIPTION

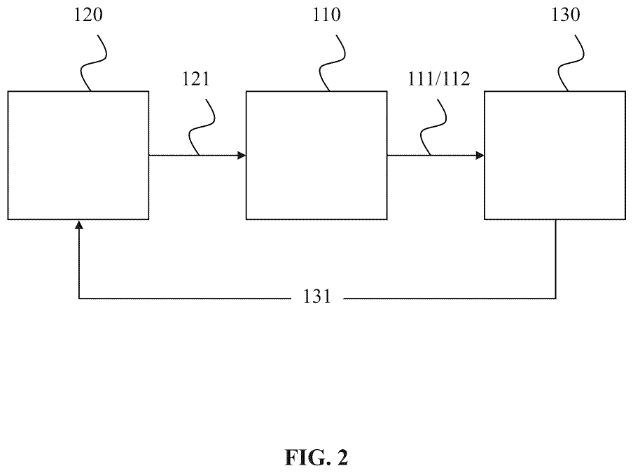

FIG. 2 shows a first node 110, a second node 120, and a third node 130, according to embodiments of this disclosure. The first node 110 is connected by RDMA connection to the second node 120 and to one or more third nodes 130 (only one third node 130 is shown as example), respectively. The second node 120 is accordingly connected by RDMA connection to the first node 110, and is also connected by RDMA connection to the one or more third nodes 130. The third node 130 is accordingly connected by RDMA connection to the first node 110 and to the second node 120, respectively.

The second node 120 may be a requestor node or initiator node, the first node 110 may be a target node or delegation node, and the third node 130 may be a serving node or storage node. Each node 110, 120, 130 may be referred to as a RDMA node, and may comprise at least a processor or processing circuitry (e.g., a CPU) and/or a RNIC.

Generally, each node 110, 120, 130 may comprise the processor or processing circuitry (not shown) configured to perform, conduct or initiate the various operations of the respective node 110, 120, 130 described below. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. Each node 110, 120, 130 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the respective node 110, 120, 130 as described below to be performed. In one embodiment, the processing circuitry comprises one or more processors and a non-transitory memory connected to the one or more processors. The non-transitory memory may carry executable program code which, when executed by the one or more processors, causes the respective node 110, 120, 130 to perform, conduct or initiate the operations or methods described below.

In particular, the second node 120 is configured to send a read request 121 for data 131 to the first node 110. Accordingly, the first node 110 is configured to receive, from the second node 120, the read request 121 for the data 131.

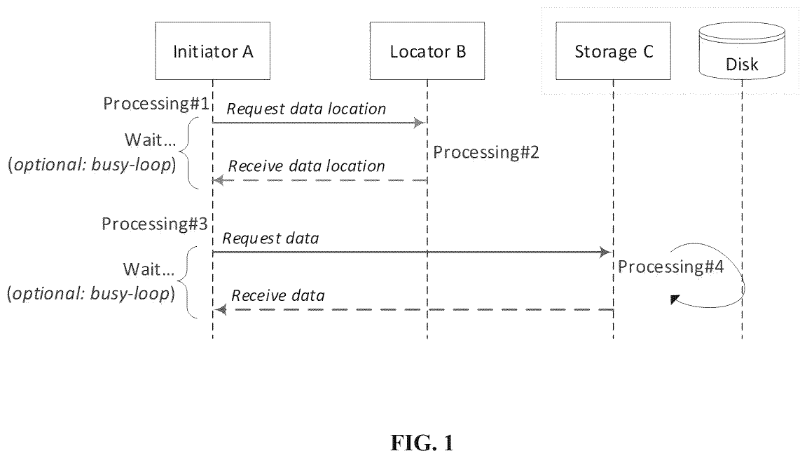

If the requested data 131 is available at the first node 110, the first node 110 may itself be configured to send the requested data 131 to the second node 120, back over the RDMA connection between the first node 110 and the second node 120 (reverse path not explicitly shown in FIG. 1). However, this disclosure is particularly concerned with the case where the requested data 131 is not available at the first node 110.

If the requested data 131 is not available at the first node 110, the first node 110 is configured to determine at which of the one or more third nodes 130 the requested data 131 is available (in this case the first node 110) determines that the data 131 is in the shown third node 130), and then to cause the determined third node 130 to send the requested data 131 over the RDMA connection between the third node 130 and the second node 120 to the second node 120. If the requested data 131 is not available at the first node 110 and if the first node 110 is also unable to determine the third node 130 at which the requested data 131 is available, the first node 110 may be configured to send a response to the second node 120 over the RDMA connection between the first node 110 and the second node 120, wherein the response indicates that the requested data is not found.

For example, for causing the determined third node 130 to provide the requested data to the second node 120, the first node 110 may be configured to trigger a write of the requested data 131 by the third node 130 into an address space of the second node 120. For triggering the write of the requested data 131 by the third node 130, the first node 110 may be configured to send at least one RDMA write request 111 to at least one of an address of a send queue at the third node 130 and an address of a doorbell register of this send queue. Alternatively, for causing the determined third node 130 to provide the requested data to the second node 120, the first node 110 may also be configured to send a read request 112 to the third node 130, wherein the read request 112 indicates that the requested data 131 is to be written by the third node 130 into the address space of the second node 120.

The third node 130 is accordingly configured to receive either the RDMA write request 111 or a send (which corresponds to the read request 112) for a command from the first node 110. These commands may be written by the first node 110 directly to the send queue at the third node 130. The third node 130 is then either configured to provide the data 131 to the second node 120 by performing a RDMA write operation or a send operation in response to the command written by the first node 110 directly to the send queue at the third node 130.

The second node 120 is accordingly configured to receive the requested data 131 from the third node 130 over the RDMA connection between the second node 120 and the third node 130. In addition, the second node 120 may obtain a notification of completion, which indicates that the requested data 131 has been written to the address space of the second node 120.

According to the above, the three nodes 110, 120, and 130 are all connected by RDMA connections to each other. The RDMA connections on each node 110, 120, 130 may be under the same RDMA protection domain, to allow positive RDMA validation checks, for example, of at least one local key (L_Key) and at least one remote key (R_Key) of one or more nodes 110, 120, 130.

In the following, two examples of implementing the above-described solution of this disclosure are presented. The first example uses a direct doorbell triggering of a queue pair (QP), while the second example does not. The first example leads to a lower overall latency. For both examples, a management process may be created in the RNIC of the first node 110, in order to handle requests 111, 112 created by the first node 110 to be sent to the third node 130. For the second example, another management process may be created in the RNIC of the third node 130, in order to handle and translate requests 112 received from the first node 110 that are destined to the second node 120. If the request from the first node 110 is the write request 111 command, the third node 130 does not require such a management process. If the request from the first node 110 is the send command, which may hold the translated read request 112, the management process may be used by the third node 130, as the send may consume a RQE from the RQ in the third node 130. This consumption may require a management process to (re) fill RQEs inside this RQ.

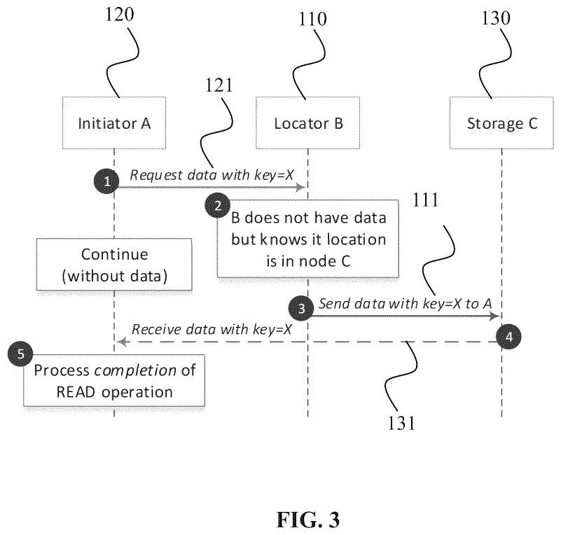

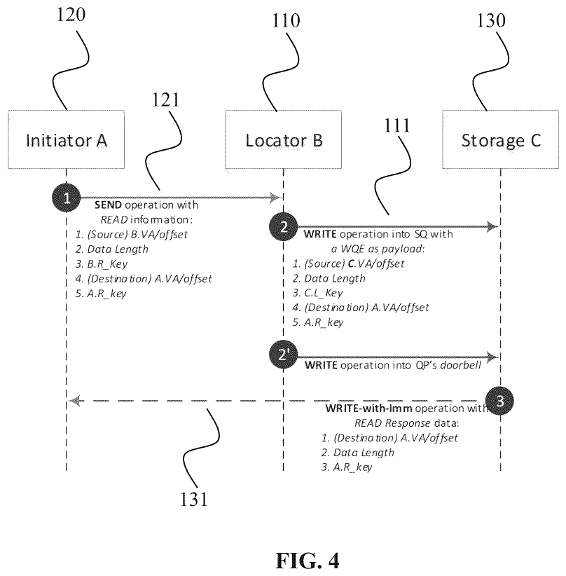

The first example is explained with reference to the FIGS. 3 and 4. In the first example, the first node 110 may have knowledge of the QP for communicating between the third node 130 and the second node 120, specifically of the send queue of the third node 130) which is for sending to the second node 120. In particular, the first node 110 may know the location of the send queue in the memory space of the third node 130, may know the size of the send queue, and may know the location of control and doorbell registers of the send queue at the third node 130. For instance, the first node 110 may comprise an address of the send queue at the third node 130 and may comprise and an address of the doorbell register of this send queue. Notably, the QP of the third node 130 can be stored in a host memory or in a RNIC or in a data processing unit (DPU) memory.

The first node 110 may be the “owner” of the QP at the third node 130 between the second node 120 and the third node 130. The first node 110 may be configured to directly, and exclusively, write requests (e.g., WQEs) into the send queue of this QP. For instance, the first node 110 may send the RDMA write request 111 to the address of the send queue at the third node 130 and/or to the address of the doorbell register of this send queue. The write request 111 may comprise information that identifies and grants access to a memory in the third node 130 and a memory in the second node 120, may comprise an address space of the third node 130, and may comprise the address space of the second node 120. “Exclusive access” of the first node 110 may mean that no other process on the third node 130 can modify this send queue's state or content.

The first node 110 may create one or more requests 111, 112 (e.g., WQEs) based on the meta-data of the RDMA operation (particularly, the read request 121 in this case), which it received from the second node 120. The first node 110 may then be configured to ring the doorbell mechanism of the QP at the third node 130, to inform the third node 130 that such a new request 111, 112 (e.g., WQE) is available. The first node 110 can further acquire all the required information about the QP at the third node 130 between the second node 120 and the third node 130 during a RDMA connection-establishment phase.

The first node 110 may moreover use auxiliary, system-dependent, data structures to translate the request 121 from the second node 120 into a corresponding request 111, 112 (e.g., WQE) to the appropriate third node 130. The implementation of these data structures may affect both the latency of the translation and how much of the first node's 110 CPU time is used to do the translation.

The second node 120 may also send, to the first node 110, only the meta-data of the operation as the request 121, which the first node 110 may then translate into one or more requests 111, 112 (appropriate WQEs) destined to the appropriate third node 130. For example, an RDMA READ operation may be already defined, e.g., as by the InfiniBand (IB) specification (see, e.g., InfiniBand Architecture Specification Volume 1, Release 1.4, April 2020), to including only the meta-data. As another example, a WRITE operation (from the second node 120 to the first node 110) may include only meta-data, and may be translated by the first node 110 into a READ operation into the memory of the third node 130.

FIG. 3 illustrates an example of a conceptual flow of messages between the nodes 110, 120, 130, to return data according to the first example of this disclosure, and shows some of the nodes' 110, 120, 130 internal operations.

In step 1 of FIG. 3, the second node 120 sends to the first node 110 the request 121 for the data 131, which may comprise the identification key X. In step 2, the first node 110 may process to locate the data 131. If the first node 110 has a cached copy of the data 131, it would return the data 131 immediately to the second node 120. In this example, however, the first node 110 does not hold the data 131, but holds information about the location of the data 131 in the third node 130.

In step 3, the first node 110 writes a write request 111 (WQE) into the send queue at the third node 130, which instructs the third node 130 to write the requested data directly to the second node 120, and rings the doorbell of the send queue at the third node 130.

In step 4, the third node 130 processes the request 111 (e.g., WQE), which is a WRITE operation into the memory space of the second node 120. This operation may also generate a completion signal, for instance a completion queue entry (CQE), of the data request 121 of the second node 120. Different methods (e.g., write with immediate, write and following send, etc.) may be used hereby. In step 5, the second node 120 processes the request's completion signal, indicating that the required data 131 is now stored in the memory space of the second node 120.

FIG. 4 is an example illustration of the RDMA operations and some important RDMA fields for returning the data 131 to the second node 120 according to the first example of this disclosure. FIG. 4 is similar to FIG. 3, but shows more RDMA details. In particular, FIG. 4 shows that the read request 121 of the second node 120 may comprise information that identifies and grants access to a memory in the first node 110 and a memory in the second node 120 (e.g., R_Key(s) of the second node 120 and the first node 110, respectively), an address space of the first node 110 (e.g., a virtual address (VA) and/or offset at the first node 110, and/or a data length), and an address space of the second node 120 (e.g., a VA and/or offset at the second node 120).

FIG. 4 further shows that the RDMA write request 111 may comprise information that identifies and grants access to a memory in the third node 130 and a memory in the second node 120 (e.g., a L_Key of the third node 130 and a R_Key of the second nodes 120), an address space of the third node 130 (e.g., a VA and/or offset at the third node 130), and the address space of the second node 120 (e.g., a VA and/or offset at the second node 120).

FIG. 4 further shows that the sending of the data 131 from the third node 130 to the second node 120 is done by, for example, a write-with immediate operation based on information that identifies and grants access to a memory in the second node 120 (e.g., a R_Key of the second node 120) and the address space of the second node 120 (e.g., a VA and/or offset at the second node 120).

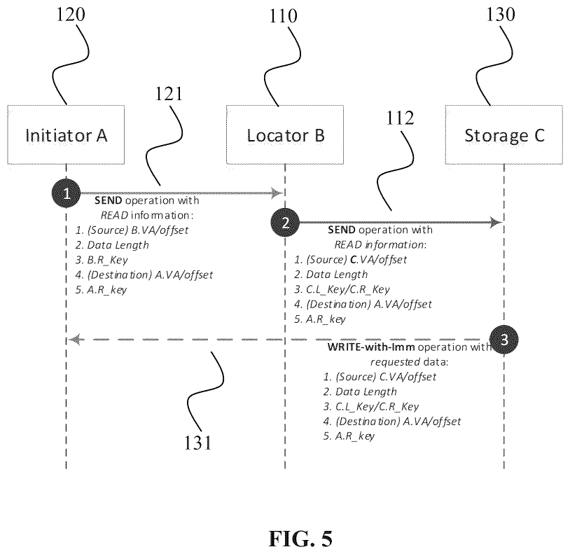

The second example is explained with reference to FIG. 5. In the second example, the third node 130 either uses its generic receiver queue (RQ) for processing any incoming request or an additional RQ (QP) for processing requests that arrives indirectly to it. The first node 110 may send all the required information to the third node 130, so that the processing may be fast at the third node 130. The special QP is managed by either a management process on the host or on the SmartNIC/DPU.

FIG. 5 shows in particular an illustration of RDMA operations and some important RDMA fields, to return data to the second node 120 according to the second example of this disclosure. The first node 110, in this second example, does not directly write to the QP's send queue and doorbell, as in the first example, but instead the first node 110 relays the request 121 it received from the second node 120 to the third node 130 with some modifications. The modifications enable the third node 130 to serve the request 121, as if the request 121 would receive from the second node 120 directly.

In step 1 of FIG. 5, the second node 120 sends a SEND operation with embedded READ information (read request 121) to the first node 110, with a destination information in the memory space of the second node 120 and with data source identification in the memory space of the first node 110.

In step 2 a management process at the first node 110 modifies the request 121 of the second node 120 into a READ request 112 that will be processed by the third node 130. The first node 110 may replace its own information (e.g. VA and/or offset, R_Key) with matching information in the memory space of the third node 130 and corresponding context.

In step 3, a management process at the third node 130 translates an incoming SEND with the READ request 112 into a WRITE-with-Immediate operation from the third node 130 to the second node 120. In this way, the data 131 is provided by the third node 130 to the second node 120.

The first example of this disclosure has the advantages that there is no CPU involvement at the third node 130 required, and that it has the lowest latency. However, the first node 110 may require some information on the QP at the third node 130 (e.g., a send queue address, a CI pointer, an L_Key, etc.). The first node 110 may also require a synchronization in some cases (e.g., read back CI value). The first node 110 may also require to handle errors of the QP of the third node 130.

The second example of this disclosure has the advantages that it is an easy modification of existing services (e.g., regarding QP type), and that the first node 110 does not require any synchronization, since the third node 130 is controlling the send queues holding commands that are translated to outbound packets sent from the third node 130 over the network. However, the third node's 130 CPU may need to handle request (e.g., post receive queue elements (RQEs) into the RQ to enable serving incoming SEND operation from the first node 110). Also, the RNIC of the third node 130 may require an additional management process. The second example of this disclosure leads also to a somewhat higher latency than the first example of this disclosure.

In an enhancement of the first example of this disclosure, the different nodes 110, 120, 130 might have each a different mapping of a WQE's structure, e.g., since the RNICs are from different manufacturing vendors. In this case each node can construct the required WQEs, based on the type and version of the RNIC installed in the node it is intended to be executed by.

Both examples of this disclosure may use a WRITE-with-Immediate RDMA opcode to send the data 131 from (storage) third node 130 to the (initiator) second node 120. WRITE-with-Immediate may be used to generate a notification to the application on the second node 120, that the data 131 is ready. Other methods to achieve this are possible, for example:
Use two separate messages: a WRITE, for the data, followed by a SEND, for notification.
Use two separate messages: a WRITE, for the data, followed by a SEND-with-Immediate, for the notification.
Use two separate messages: a WRITE, for the data, followed by a WRITE-with-Immediate, for the notification.
Use any operation that can trigger a notification after the first operation.
The second node 120 can poll for completion.

The third node 130 might also be another caching system with more hierarchy levels of data access. For example, the third node 130 may be a storage system and the data 131 is not in its memory, but instead is stored in an array of HDDs or SSDs. The third node 130 may load the required data to its memory, before it sends the data 131 directly to the second node 120. Alternatively, if the third node 130 is a storage system that supports the Non Volatile Memory express (NVMe) over Fabrics (NVMe-oF) protocol, the solutions of this disclosure can be integrated with the NVMe-oF protocol, so that said protocol is responsible for sending the data 131 to the second node 120. Any cascade from the third node 130 to another service node may also be used, which may happen if the data 131 (e.g., a chunk) is temporally unavailable at the third node 130.

The solutions of this disclosure can be extended to remote control of a graphics processing unit (GPU), so that the GPU's post processing of data 131 is sent directly to the initiator (second node 120), e.g., for accelerating video games over a network where a rendered picture is directly sent to the second node 120 rather than through any kind of front-end server.

The solutions of this disclosure can also be extended for use by a remote management application, for instance, to transfer data from multiple distributed application nodes. The solutions of this disclosure can also utilize a DPU, and all intended processing can be executed in one or more DPUs, instead of on the node's CPUs.

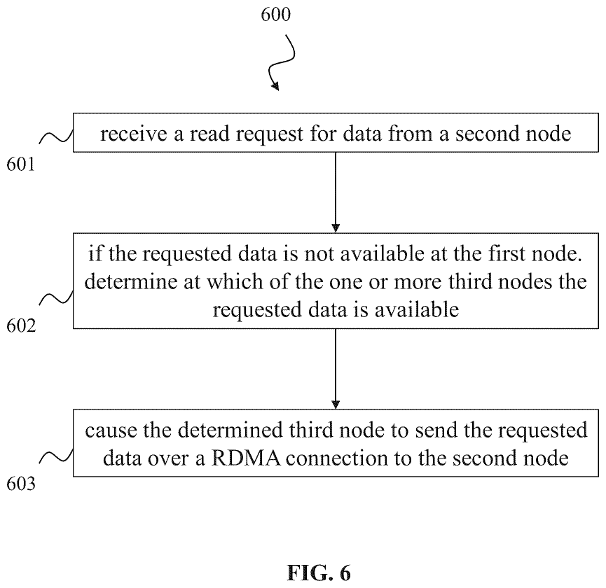

FIG. 6 shows a method 600 for a first node 110 according to this disclosure. The first node 110 may perform the method 600. The first node 110 is connected by RDMA connection to a second node 120 and to one or more third nodes 130, respectively, as already described above.

The method comprises a step 601 of receiving, from the second node 120, a read request 112 for data 131. If the requested data 131 is not available at the first node 110, the method comprises a step 602 of determining at which of the one or more third nodes 130 the requested data 131 is available, and a step 603 of causing the determined third node 130 to send the requested data 131 over a RDMA connection to the second node 120.

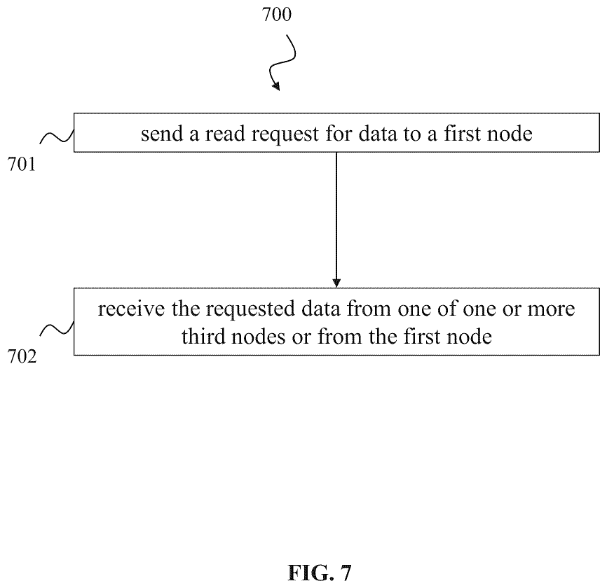

FIG. 7 shows a method 700 for a second node 120 according to this disclosure. The second node 120 may perform the method 700. The second node 120 is connected by RDMA connection to a first node 110 and to one or more third nodes 130, respectively, as already described above.

The method 700 comprises a step 701 of sending a read request 121 for data 131 to the first node 110, and a step 702 of receiving the requested data 131 from one of the third nodes 130.

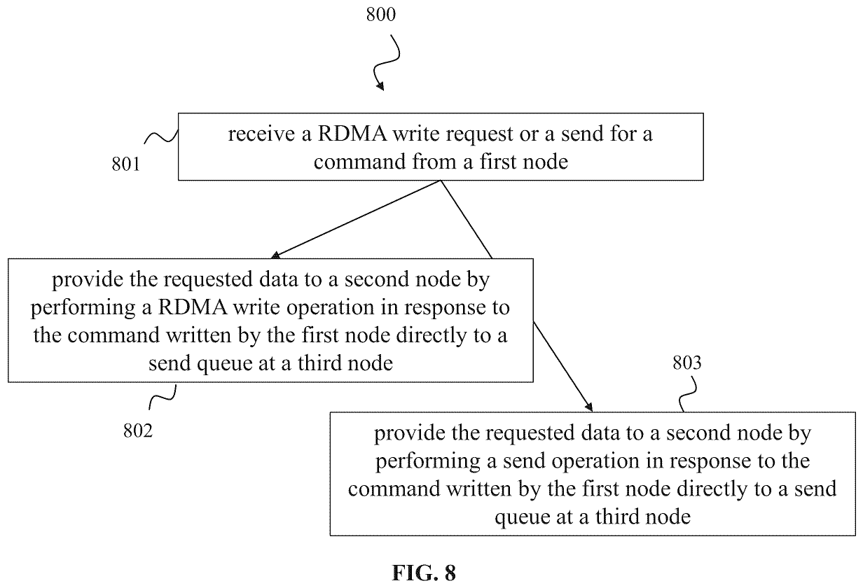

FIG. 8 shows a method 800 for a third node 120 according to this disclosure. The third node 130 may perform the method 800. The third node 130 is connected by RDMA connection to a first node 110 and to a second node 120, respectively, as already described above.

The method 800 comprises a step 801 of receiving a RDMA write request 111 or a send 112 for a command from the first node 110. Then, the method 800 comprises either a step 802 of providing the requested data 131 to the second node 120 by performing a RDMA write operation in response to the command written by the first node 110 directly to a send queue at the third node 130; or the method 800 comprises a step 803 of providing the requested data 131 to the second node 120 by performing a send operation in response to the command written by the first node 110 directly to a send queue at the third node 130.

The solutions of this disclosure allow for faster IO operations when more than two nodes are participating in the data 131 exchange, thus allowing for a faster operation of applications on an initiator node (second node 120), as remote data becomes available faster. The solutions of this disclosure reduce the requirements for CPU processing in the requesting node (in this document the second node 120), and for the first example of this disclosure also for the servicing node (in this document the third node 130). This reduced CPU usage means a single delegating node (in this document the first node 110) can handle and connect to more servicing nodes, thus improving the scale of disaggregated and distributed storage systems. The solutions of this disclosure reduce overall network traffic, as fewer network packets for control are used. The solutions of this disclosure also enable a more efficient operation of the initiator node, as it reduces the handling of negative responses of the type “requested data is located in another node”. The efficiency increases also by reducing the number of required requests to be generated, and the total time needed to wait for the responses.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A first node, which is connected to a second node and one or more third nodes by remote direct memory access (RDMA) connection, the first node comprising:
a processor; and
a memory coupled to the processor and having processor-executable instruction stored thereon, which upon execution by the processor, cause the first node to:
receive, from the second node, a read request for requested data; and
based on the requested data not being available at the first node:
determine at which of the one or more third nodes the requested data is available;
cause the determined third node to send the requested data over a third RDMA connection to the second node; and
wherein the first node is connected to the second node by a first RDMA connection.
wherein the first node is connected to the one or more third nodes by a second RDMA connection; and
wherein the second node is connected to the one or more third nodes by the third RDMA connection.

2. The first node according to claim 1, wherein the read request comprises information that identifies and grants access to a memory in the first node and a memory in the second node, an address space of the first node, and an address space of the second node.

3. The first node according to claim 1, wherein for causing the determined third node to provide the requested data to the second node, the first node is configured to trigger a write of the requested data by the determined third node into the address space of the second node.

4. The first node according to claim 3, wherein the processor further executes the processor-executable instructions to cause the first node to: control the third RDMA connection from the determined third node to the second node.

5. The first node according to claim 3, wherein the first node comprises an address of a send queue at the third node, for sending from the third node to the second node, and an address of a doorbell register of the send queue.

6. The first node according to claim 3, wherein for triggering the write of the requested data by the third node, the first node is configured to send at least one RDMA write request to the address of the send queue at the third node and/or to the address of the doorbell register of this send queue.

7. The first node according to claim 6, wherein the at least one RDMA write request comprises information that identifies and grants access to a memory in the third node and a memory in the second node, an address space of the third node, and the address space of the second node.

8. The first node according to claim 6, wherein the at least one RDMA write request comprises one of:
a RDMA write-with-immediate request for the requested data and for a notification;
a RDMA write request for the requested data and a send request for a notification;
a RDMA write request for the requested data and a send-with-immediate request for a notification.

9. The first node according to claim 1, wherein for causing the determined third node to provide the requested data to the second node, the first node is configured to send a read request to the determined third node, wherein the read request indicates that the requested data is to be written by the determined third node into the address space of the second node.

10. The first node according to claim 9, wherein the read request comprises information that identifies and grants access to a memory in the determined third node and a memory in the second node, and the address space of the second node.

11. The first node according to claim 1, wherein the processor further executes the processor-executable instructions to cause the first node to: based on the requested data being available at the first node, send the requested data to the second node over the first RDMA connection to the second node.

12. The first node according to claim 1, wherein the processor further executes the processor-executable instructions to cause the first node to: based on the requested data not being available at the first node and based on the first node being unable to determine the determined third node at which the requested data is available, send a response to the second node indicating that the requested data is not found.

13. A second node, which is connected to a first node and to one or more third nodes, by remote direct memory access RDMA) connection, the second node comprising:
a processor; and
a memory coupled to the processor and having processor-executable instruction stored thereon, which upon execution by the processor, cause the second node to:
send a read request for requested data to the first node;
receive the requested data from one of the one or more third nodes; and
wherein the first node is connected to the second node by a first RDMA connection,
wherein the first node is connected to the one or more third nodes by a second RDMA connection; and
wherein the second node is connected to the one or more third nodes by a third RDMA connection.

14. The second node according to claim 13, wherein the read request comprises information that identifies and grants access to a memory in the first node and to a memory in the second node, an address space of the first node, and an address space of the second node.

15. The second node according to claim 13, wherein the processor further executes the processor-executable instructions to cause the second node to:
obtain a notification of completion which indicates that the requested data has been written to the address space of the second node, wherein the notification of completion is obtained by one of:
polling a completion queue of the second node for the notification of completion after sending the read request;
receiving an event indicating that the notification of completion can be polled from the completion queue.

16. A third node, which is connected to a first node and a second node by remote direct memory access (RDMA) connection, the third node comprising:
a processor; and
a memory coupled to the processor and having processor-executable instruction stored thereon, which upon execution by the processor, cause the third node to:
receive a RDMA write request or a send a command from the first node (110);
implement one of the following:
providing data to the second node by performing a RDMA write operation in response to the command written by the first node directly to a send queue at the third node; or
providing the data to the second node by performing a send operation in response to the command written by the first node directly to the send queue at the third node; and
wherein the first node is connected to the second node by a first RDMA connection,
wherein the first node is connected to the third node by a second RDMA connection; and
wherein the second node is connected to the third node by a third RDMA connection.

17. The third node according to claim 16, wherein the processor further executes the processor-executable instructions to cause the third node to:
perform, as the RDMA write operation, a write-with-immediate, or a write and send operations, or a write and send-with-immediate operations.

18. The third node according to claim 16, wherein the processor further executes the processor-executable instructions to cause the third node to:
execute the command written to the send queue at the third node that provides the data into an address space of the second node.

19. The third node according to claim 16, wherein, based on the first node directly writing the command to the send queue of the third node, the third node is configured to:
provide the data to the second node without processing at the third node, and/or without controlling a receive queue at the third node, for sending from the third node to the second node, and a doorbell register of the send queue.

20. The third node according to claim 16, wherein, based on the third node receiving the command via a send from the first node, the third node is configured to:
provide the data to the second node by initiating the execution of the operation indicated by the RDMA command to the second node, and/or by controlling a receive queue at the third node, for sending from the third node to the second node.

21. A method for a first node, which is connected to a second node and to one or more third nodes, by remote direct memory access (RDMA) connection, the method comprising:
receiving, from the second node, a read request for requested data;
based on the requested data not being available at the first node:
determining at which of the one or more third nodes the requested data is available;
causing the determined third node to send the requested data over a third RDMA connection to the second node; and
wherein the first node is connected to the second node by a first RDMA connection,
is connected to the one or more third nodes by a second RDMA connection; and
the second node is connected to the one or more third nodes by the third RDMA connection.

22. A method for a second node, which is connected to a first node and to one or more third nodes, by remote direct memory access (RDMA) connection, the method comprising:
sending a read request for requested data to the first node;
receiving the requested data from one of the one or more third nodes; and
wherein the first node is connected to the second node by a first RDMA connection,
wherein the first node is connected to the one or more third nodes by a second RDMA connection; and
wherein the second node is connected to the one or more third nodes by a third RDMA connection.

23. A method for a third node, which is connected to a first node and to a second node, by remote direct memory access (RDMA) connection, the method comprising:
receiving a RDMA write request or a send for a command from the first node;
implementing one of the following:
providing the requested data to the second node by performing a RDMA write operation in response to the command written by the first node directly to a send queue at the third node; or
providing the requested data to the second node by performing a send operation in response to the command written by the first node directly to the send queue at the third node; and
wherein the first node is connected to the second node by a first RDMA connection,
wherein the first node is connected to the third node by a second RDMA connection; and
wherein the second node is connected to the third node by a third RDMA connection.

24. A non-transitory computer readable medium comprising instructions which, upon being executed by a computer, cause the computer to perform the method claim 21.
